(19) United States
(12) Patent Application Publication
(10) Pub. No.: US 2013/0198408 A1
(43) Pub. Date: Aug. 1, 2013

(54) IP Parameter Determination and Configuration

(71) Applicant: Richard A. Blair, Plaistow, NH (US)

(72) Inventor: Richard A. Blair, Plaistow, NH (US)

(73) Assignee: SCHNEIDER ELECTRIC INDUSTRIES SAS, Rueil Malmaison (FR)

(21) Appl. No.: 13/359,091

(22) Filed: Jan. 26, 2012

(51) Int. Cl. G06F 15/16

(52) U.S. Cl. 709/237

(57) ABSTRACT

An enhanced Internet Protocol (IP) parameter device may aid in configuring and/or determining the IP parameters of a device. The enhanced IP parameter device may first wait for a message requesting a network address from the device. This message may be sent using a variety of communication protocols, including Bootstrap Protocol (BOOTP) and Dynamic Host Configuration Protocol (DHCP). Once this message is received, a handshaking procedure may be completed and the enhanced IP parameter device may then transmit IP parameters to the device. Alternatively, the device may also transmit a message using Address Resolution Protocol (ARP) to allow the enhanced IP parameter device to determine the IP address assigned to the device. Finally, if the device does not transmit any message, the enhanced IP parameter device may search a predetermined range of IP addresses or use Inverse Address Resolution Protocol (IARP) or Reverse Address Resolution Protocol (RARP).

### TECHNICAL FIELD

Aspects of the invention generally relate to methods and systems for setting or determining Internet Protocol (IP) parameter information for a device.

### BACKGROUND

Different devices on a network are assigned a unique Internet Protocol (IP) address so that they can be properly identified. When a device is first connected to a network, the device may obtain its IP address in a variety of ways. For instance, the device may include switches located on the device that instruct the device how to initially obtain its IP address. In one example, a network server may be used to serve an IP address to the device. Different servers may be needed for devices that use different types of networking protocols (e.g., Bootstrap Protocol (BOOTP), Dynamic Host Configuration Protocol (DHCP), etc.). These protocols may be described in various requests for comments (RFCs) published by the Internet Engineering Task Force (IETF) (e.g., RFC 826, 951, 1531, 1532, 1541, 1542, 2131, 5227, etc.).

Thus, multiple servers may be needed to serve IP addresses to all the devices within a given network. Once a device has obtained its IP address, the network configuration of the device may be modified by accessing the device through the assigned IP address, such as via a webpage.

In addition, devices that have already been allocated IP addresses during a previous session may exist in a system or network. However, these IP addresses may not be known when the devices are ready for use. Thus, for these devices, an IP address initialization procedure, such as the one described above, must be repeated.

Thus, configuring a new IP address or determining a pre-allocated IP address for a device can be a time-consuming and inefficient process that involves multiple network elements. These problems are only exacerbated when dealing with embedded devices (such as those that typically exist in automation control systems) that generally do not have user interfaces, such as monitors or keypads, for easy access to the device. Therefore, there is a need for new strategies for configuring/managing device IP parameter information.

### BRIEF SUMMARY

In light of the foregoing background, the following presents a simplified summary of the present disclosure in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

Aspects of the disclosure address one or more of the issues mentioned above by disclosing methods, non-transitory computer readable media, and apparatuses for configuring and/or determining IP parameter information within a device prior to connecting the device to a network. An enhanced Internet Protocol (IP) parameter device may be used to set IP parameters within a device and/or determine the IP parameters that have already been set on the device.

Other aspects of the disclosure relate to an enhanced IP parameter device that may use various protocols, such as Bootstrap Protocol (BOOTP) and Dynamic Host Configuration Protocol (DHCP), to set and/or obtain a device's IP parameters. In yet other aspects, the enhanced IP parameter device may determine static IP parameters that have been stored in the device.

Aspects of the disclosure may be provided in a computer-readable medium having computer-executable instructions that, when executed, cause a computer or other apparatus to perform one or more of the process steps described herein.

### BRIEF DESCRIPTION OF THE DRAWINGS

The example embodiments are illustrated by way of example in the accompanying figures in which:

FIG. 1 shows an illustrative operating environment in which various aspects of the disclosure may be implemented.

FIG. 2 shows a diagram of an enhanced IP parameter device connected to another device via an Ethernet port in accordance with one or more aspects of the disclosure.

FIG. 3 shows an example flow diagram of steps performed for setting and/or determining IP parameters in a device, in accordance with one or more aspects of the disclosure.

### DETAILED DESCRIPTION

As described above, configuring and/or managing Internet Protocol (IP) parameter information within devices can be a time-consuming and/or inefficient process. Therefore, the example embodiments of this disclosure provide novel methodologies to configure or determine the IP address of a device prior to connecting the device to a network, regardless of the communication protocols used by the device.

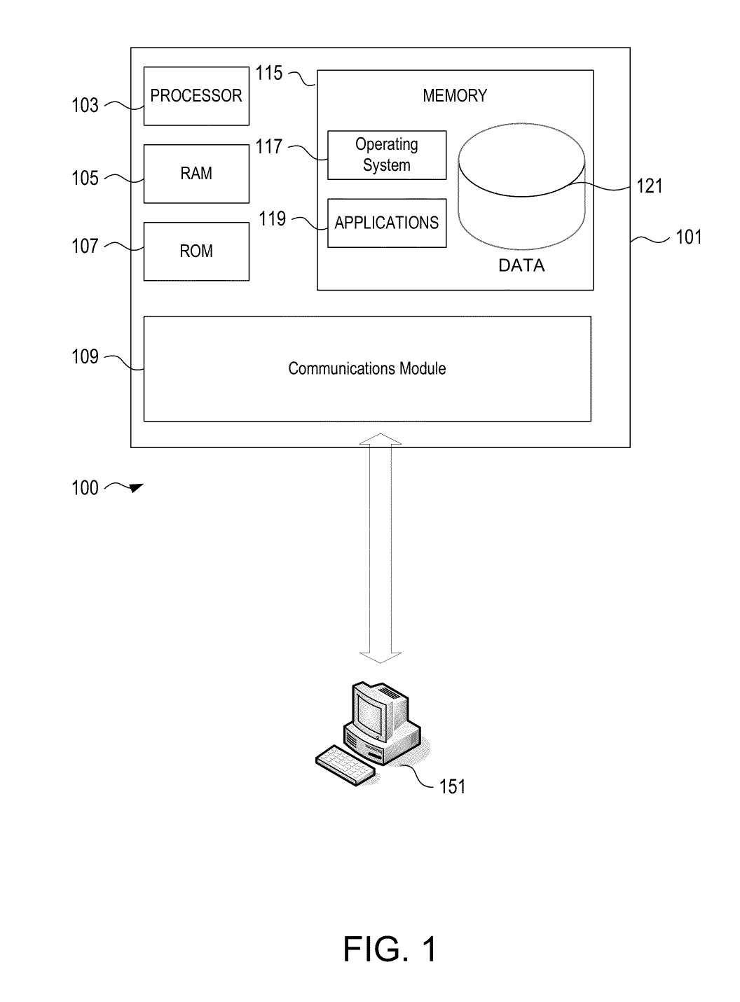

FIG. 1 illustrates an example of a suitable computing system environment 100 that may be used according to one or more illustrative embodiments. The computing system environment 100 is only one example of a suitable computing environment and is not intended to suggest any limitation as to the scope of use or functionality contained in the disclosure. The computing system environment 100 should not be interpreted as having any dependency or requirement relating to any one or combination of components shown in the illustrative computing system environment 100.

The disclosure is operational with numerous other general purpose or special purpose computing system environments or configurations. Examples of well known computing systems, environments, and/or configurations that may be suitable for use with the disclosed embodiments include, but are not limited to, personal computers (PCs), server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

With reference to FIG. 1, the computing system environment 100 may include an enhanced IP parameter device 101 wherein the processes discussed herein may be implemented. The device 101 may have a processor 103 for controlling overall operation of the computing device 101 and its associated components, including random-access memory (RAM) 105, read-only memory (ROM) 107, communications module 109, and memory 115. Processor 103 and its associated components may allow device 101 to run a series of computer-readable instructions related to communicating with another device for sending/receiving IP parameter information. Processor 103 may also direct device 101 to wait for an initial message from another device (e.g., an input/output (I/O device), etc.) before searching for IP addresses stored in a memory of the I/O device.

Computing device 101 typically includes a variety of computer readable media. Computer readable media may be any available media that may be accessed by computing device 101 and include both volatile and nonvolatile media, removable and non-removable media. By way of example, and not limitation, computer-readable media may comprise a combination of computer storage media and communication media.

Computer storage media include volatile and nonvolatile, removable and non-removable media implemented in any method or technology for storage of information such as computer readable instructions, data structures, program modules or other data. Computer storage media include, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by computing device 101.

Communication media typically embodies computer readable instructions, data structures, program modules or other data in a modulated data signal such as a carrier wave or other transport mechanism and includes any information delivery media. Modulated data signal includes a signal that has one or more of its characteristics set or changed in such a manner as to encode information in the signal. By way of example, and not limitation, communication media includes wired media such as a direct-wired connection (e.g., Ethernet, etc.), and wireless media such as acoustic, RF, infrared and other wireless media.

Although not shown, RAM 105 may include one or more applications representing the application data stored in RAM 105 while the computing device 101 is on and corresponding software applications (e.g., software tasks) are running on the computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output. Module 109 may also support a direct-wired and/or wireless connection for communicating with another device.

Software may be stored within memory 115 and/or storage to provide instructions to processor 103 for enabling computing device 101 to perform various functions. For example, memory 115 may store software used by the computing device 101, such as an operating system 117, application programs 119, and an associated database 121. Also, some or all of the computer executable instructions for computing device 101 may be embodied in hardware or firmware.

Computing device 101 may support a point-to-point connection to a computing device 151 (e.g., an I/O device within an automation control network, a programmable logic controller (PLC), etc.). The computing device 151 may be a computing device that includes many or all of the elements described above relative to the computing device 101.

Additionally, one or more application programs 119 used by the computing device 101, according to an illustrative embodiment, may include computer executable instructions for invoking user functionality related to communication including voice input and speech recognition applications (e.g., for transmitting/receiving IP parameter information, etc.). In addition, the application programs 119 may include computer executable instructions for invoking functionality related to handling multiple communication protocols for configuring IP parameters in an embedded device prior to connecting the device to a network.

Embodiments of the disclosure may include forms of computer-readable media. Computer-readable media include any available media that can be accessed by computing device 101. Computer-readable media may comprise storage media and communication media and in some examples may be non-transitory. Storage media include volatile and nonvolatile, removable and non-removable media implemented in any method or technology for storage of information such as computer-readable instructions, object code, data structures, program modules, or other data. Communication media include any information delivery media and typically embody data in a modulated data signal such as a carrier wave or other transport mechanism.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed embodiments is contemplated. For example, aspects of the method steps disclosed herein may be executed on a processor 103 on enhanced IP parameter device 101. Such a processor may execute computer-executable instructions stored on a computer-readable medium.

The steps that follow in the Figures may be implemented by one or more of the components in FIG. 1 and/or other components, including other computing devices.

In accordance with various aspects of the disclosure, methods, computer-readable media, and apparatuses are disclosed for configuring and/or determining IP parameter information associated with a device.

To implement this solution, an enhanced IP parameter device 101 may be configured to run computer-executable program instructions related to each step of an IP parameter configuration and management process. Device 101 may interface with different types of devices (e.g., devices 151), including embedded devices with no user interface, such as those typically found in automation control systems. In addition, IP parameter device 101 may use a variety of communication protocols and procedures for determining and/or configuring IP parameter information within a device prior to connecting the device to a network. For example, enhanced IP parameter device 101 may support BOOTP and/or DHCP, among other types of communication protocols. In addition, device 101 may retrieve static IP parameters stored within another device (e.g., using protocols such as PING, Reverse Address Resolution Protocol (RARP), and/or Inverse Address Resolution Protocol (IARP)).

In one embodiment, the enhanced IP parameter device 101 may be a handheld instrument that may be easily moved from one location to another. In other embodiments, device 101 may be a laptop and/or a desktop that runs computer-executable program instructions for IP parameter configuration and management.

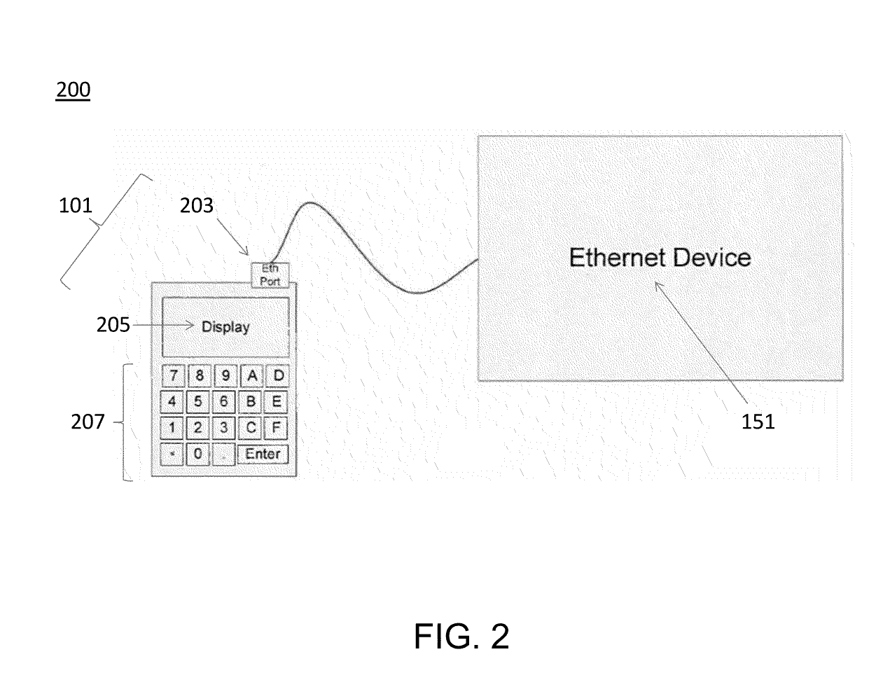

FIG. 2 shows a diagram 200 of an enhanced IP parameter device 101 connected to another device 151 via an Ethernet port 203, in accordance with at least one aspect of the disclosure. As shown in FIG. 2, enhanced IP parameter device 101 may include a communication port 203 (e.g., an Ethernet port, etc.), a display 205, and a keypad 207. In the embodiment shown in FIG. 2, device 101 is connected to another device 151 via an Ethernet cable. In other embodiments, device 101 may be connected to another device 151 via some other type of wired or wireless connection. In one embodiment, enhanced IP parameter device 101 may be battery-powered.

Once enhanced IP parameter device 101 has been connected to another device 151, enhanced IP parameter device 101 may be used to determine or configure IP parameters of device 151. In some aspects, device 151 may be an industrial device that supports the EtherNet Industrial Protocol (EtherNet/IP) or Modbus® protocol. Device 101 may retrieve the IP parameters (e.g., IP address, subnet mask, default gateway, device or domain name server (DNS) name, method of IP acquisition, etc.) of device 151 and display this information. Examples of various methods of IP acquisition include BOOTP, DHCP, PING, IARP, RARP, and Modbus requests, among other methods. In this regard, device 101 may include both a BOOTP and DHCP server.

After device 101 retrieves the necessary IP parameters of device 151, new parameter values may be set. Once the new values have been stored in a memory (e.g., flash, etc.) of the device 151, device 151 may be placed into operation.

Enhanced IP parameter device 101 may communicate with a device 151 regardless of whether device 151 is a “factory-fresh” device or a device that is already “on the shelf.” In the case that device 151 is a “factory-fresh” device, device 101 may be used to configure the IP parameters of device 151 before placing the device 151 into service.

When device 151 already exists within a system/network (e.g., on the shelf), the IP parameters of device 151 may have been forgotten or misplaced. Enhanced IP parameter device 101 may be used to determine the IP parameters of device 151. Once the IP parameters of device 151 are known, device 101 may be used to reconfigure the IP parameters to match any new intended installation requirements of device 151. Once the IP parameters of device 151 have been properly configured by enhanced IP parameter device 101, additional parameters of device 151 may be configured using other tools specific for that device (e.g., via a webpage).

To serve IP parameters to devices 151, enhanced IP parameter device 101 may store a default set of parameters, such as its IP address, subnet mask, default gateway, DHCP and BOOTP served address ranges and link parameters (e.g., link speed (auto, 10 MB, 100 MB, 1000 MB, etc.), duplex mode (auto, full, half), etc.). These parameters may be altered by a user and saved in a memory (e.g., nonvolatile, etc.) of device 101.

In operation, device 101 may detect/configure IP parameters associated with a device 151 in one of several ways, according to various aspects of the disclosure. If device 151 uses DHCP, enhanced IP parameter device 101 may detect a DHCP request from device 151. After receiving a DHCP request from device 151, device 101 may complete a DHCP handshaking procedure to provide IP parameters to device 151. Any DHCP options that device 151 transmits to enhanced IP parameter device 101 in the DHCP request may be displayed to a user on the display screen 205 of enhanced IP parameter device 101. In addition, the IP parameters that may be served to device 151 may be displayed on screen 205. The display of these IP parameters may help a user connect to device 151 with other hardware/software tools (e.g., web browsers, etc.) at a later time.

If device 151 uses BOOTP, enhanced IP parameter device 101 may detect a BOOTP request from device 151. After receiving a BOOTP request from device 151, device 101 may complete a BOOTP handshaking procedure to provide IP parameters to device 151. Because enhanced IP parameter device 101 may be used for configuring device 151, the BOOTP address assigned to device 151 may not be based on an address translation table; rather, the IP address assigned to device 151 may be randomly assigned from a pool of addresses (e.g., an address within a certain range to be able to communicate with device 151). As with the DHCP procedure discussed above, the served IP parameters may be displayed on screen 205 of enhanced IP parameter device 101 so that a user may use this information to connect to device 151 with other hardware/software tools.

If device 151 includes static IP parameters stored in memory, device 151 may transmit a message to check for duplicate IP addresses (e.g., a gratuitous Address Resolution Protocol (ARP) message, etc.). Enhanced IP parameter device 101 may detect this message to determine the IP address of device 151. Device 101 may then use the detected IP address to communicate with device 151. As part of this process, enhanced IP parameter device 101 may need to change its own IP address so that its IP address is within the same subnet as device 151.

If device 151 does not transmit a message to check for duplicate IP addresses and does not transmit a request for a network address, enhanced IP parameter device 101 may search for device 151 over a range of IP addresses using various types of protocols, including PING, EtherNet/IP, Modbus, etc. If known, device 101 may also use the media access control (MAC) address of device 151. In this scenario, enhanced IP parameter device 101 may use protocols such as the Reverse Address Resolution Protocol (RARP) or Inverse Address Resolution Protocol (IARP) to obtain the IP address of device 151 from the MAC address. Once device 101 determines the IP address of device 151, device 101 may obtain the remaining IP parameters from device 151 (e.g., via a Transmission Control Protocol (TCP) object in EtherNet/IP, Modbus requests, etc.) Once enhanced IP parameter device 101 has determined the IP parameters associated with device 151, these parameters may be made available to a user (such as via display 205, etc.) so that the user may use these parameters to connect device 151 with other software/hardware tools and/or web browsers.

Once device 151 has a known IP address, enhanced IP parameter device 101 and/or existing hardware/software tools may be used to further configure device 151. For instance, if the device 151 is a programmable logic controller (PLC), a personal computer may be used to transmit a PLC program to device 151 using the known IP address. In other embodiments, device 151 may be any number of other devices, including an input/output (I/O) device and a drive for a motor, among other things.

If enhanced IP parameter device 101 is used to further configure device 151, keypad 207 may be used to program new IP parameters into device 151. For instance, a user may use a “set” operation for a TCP/IP object in EtherNet/IP or a Modbus “write” operation to configure IP parameters of device 151.

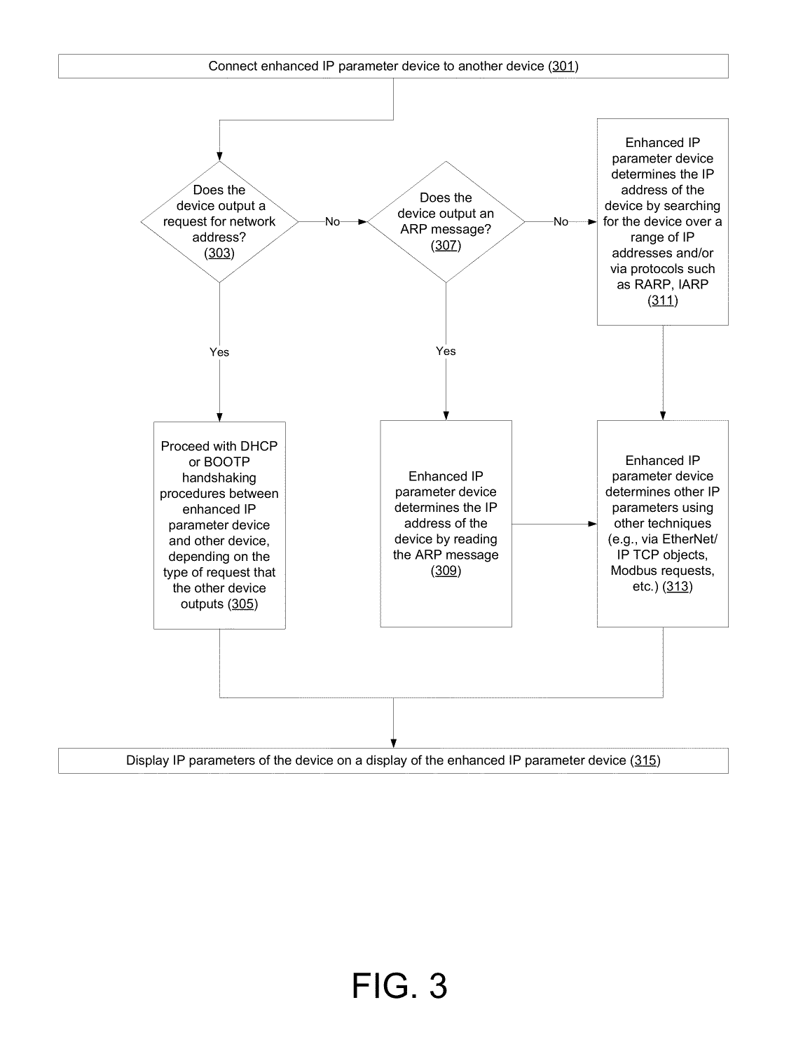

FIG. 3 shows an example flow diagram of steps performed for setting and/or determining IP parameters in a device, in accordance with at least one aspect of the disclosure. The process shown in FIG. 3 may start out at step 301 where an enhanced IP parameter device (e.g., device 101) may be connected to another device (e.g., device 151). As shown in FIG. 2, the connection may be made via an Ethernet cable, among other things. Once a connection is established between enhanced IP parameter device 101 and device 151, the process may move to decision step 303 where the enhanced IP parameter device 101 may decide if the device 151 is outputting a request for a network address.

If the device 151 is outputting a request for a network address, the process may move to step 305 where a DHCP or BOOTP handshaking procedure may be completed between the device 151 and the enhanced IP parameter device 101 based on the type of request that the device 151 outputs. As part of the DHCP or BOOTP handshaking procedure, enhanced IP parameter device 101 may transmit IP parameters to the device 151.

If the device 151 is not outputting a request for a network address in step 303, the process may move to step 307 where the enhanced IP parameter device 101 may decide if the device 151 is outputting an ARP message. If the device 151 is outputting an ARP message, enhanced IP parameter device 101 may determine the IP address of the device 151 by reading the ARP message in step 309. If the device 151 is not outputting an ARP message, enhanced IP parameter device 101 may determine the IP address of the device 151 by searching for the device 151 over a range of IP addresses in step 311. If the MAC address of the device 151 is known, enhanced IP parameter device 101 may also use communication protocols such as the Reverse Address Resolution Protocol (RARP) and/or Inverse Address Resolution Protocol (IARP) to obtain the IP address of device 151 from the MAC address.

After step 309 or step 311, the process may move to step 313 where the enhanced IP parameter device 101 may determine other IP parameters (e.g., subnet mask, default gateway, device or domain name server (DNS) name, method of IP acquisition, etc.) of the device 151 using other techniques (e.g., EtherNet/IP TCP objects, Modbus requests, etc.). Finally, after step 305 or step 313, the process may move to step 315 where the enhanced IP parameter device 101 may display IP parameters of the device 151 on a display (e.g., display 205) associated with device 101 so that a user may connect with device 151 using the displayed IP parameters with other hardware/software tools.

Aspects of the disclosure have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the invention.

What is claimed is:

1. A non-transitory computer-readable storage medium having computer-executable program instructions stored thereon that when executed by a processor, cause the processor to perform steps comprising:
waiting for a message sent using a first communication protocol from a device;
if the message is received:
analyzing the message;
when the message comprises a request for a network address from the device, completing a handshaking procedure with the device based on the first communication protocol and transmitting Internet Protocol (IP) parameters to the device using the first communication protocol; and
when the message includes an IP address of the device, storing the IP address in a memory and determining other IP parameters of the device by communicating with the device using a second communication protocol;
if the message is not received:
searching for the IP address of the device over a predetermined range of IP addresses using a third communication protocol;
determining the IP address of the device based on the search; and
determining the other IP parameters of the device by communicating with the device using the third communication protocol.

2. The non-transitory computer-readable storage medium of claim 1, wherein the first communication protocol is chosen from the group consisting of: Bootstrap Protocol (BOOTP), Dynamic Host Configuration Protocol (DHCP), and Address Resolution Protocol (ARP).

3. The non-transitory computer-readable storage medium of claim 1, wherein the second communication protocol is one of EtherNet Industrial Protocol (EtherNet/IP) and Modbus.

4. The non-transitory computer-readable storage medium of claim 1, wherein the third communication protocol is chosen from the group consisting of: PING, EtherNet Industrial Protocol (EtherNet/IP), and Modbus.

5. The non-transitory computer-readable storage medium of claim 1, wherein the processor further performs: if the message is not received, using one of Reverse Address Resolution Protocol (RARP) and Inverse Address Resolution Protocol (IARP) to obtain the IP address of the device from a media access control (MAC) address of the device.

6. The non-transitory computer-readable storage medium of claim 1, wherein the processor further performs: displaying the IP address of the device on a display.

7. The non-transitory computer-readable storage medium of claim 1, wherein the device comprises a programmable logic controller (PLC).

8. The non-transitory computer-readable storage medium of claim 1, wherein the IP parameters comprise the IP address, a subnet mask, a default gateway, a device or domain name server (DNS) name, and a method of IP acquisition for the device.

9. The non-transitory computer-readable storage medium of claim 8, wherein the processor further performs: communicating with the device to set the IP address and the other IP parameters of the device to a plurality of new values.

10. The non-transitory computer-readable storage medium of claim 1, wherein the processor further performs: using a keypad, programming new IP parameters into the device.

11. A computer-assisted method comprising:
using a processor associated with a computer, determining if a message is received from a device using a first communication protocol;
if the message is received:
using the processor, analyzing the message;
when the message comprises a request for a network address from the device, using the processor, completing a handshaking procedure with the device based on the first communication protocol and transmitting an Internet Protocol (IP) address to the device using a communication port associated with the computer; and
when the message includes the IP address of the device, storing the IP address in a memory associated with the computer;
if the message is not received:
using the communication port, searching for the IP address of the device over a predetermined range of IP addresses using a second communication protocol; and
using the processor, determining the IP address of the device based on the search.

12. The computer-assisted method of claim 11, further comprising: using the communication port, transmitting other IP parameters to the device.

13. The computer-assisted method of claim 12, wherein the other IP parameters include a subnet mask, a default gateway, a device or domain name server (DNS) name, and a method of IP acquisition for the device.

14. The computer-assisted method of claim 11, wherein the first communication protocol is chosen from the group consisting of: Bootstrap Protocol (BOOTP), Dynamic Host Configuration Protocol (DHCP), and Address Resolution Protocol (ARP).

15. The computer-assisted method of claim 11, wherein the computer comprises a handheld device.

16. The computer-assisted method of claim 15, wherein the handheld device modifies an IP address that the handheld device has been assigned so that the handheld device is within a same subnet as the device.

17. An apparatus comprising:
a processor; and
a memory storing computer-readable instructions that, when executed by the processor, cause the apparatus at least to perform:
waiting for a message sent using one of Bootstrap Protocol (BOOTP) and Dynamic Host Configuration Protocol (DHCP) from a device;
if the message is received:
analyzing the message;
when the message comprises a request for a network address from the device, completing a handshaking procedure with the device based on the one of the BOOTP and the DHCP and transmitting an Internet Protocol (IP) address to the device;
when the message includes the IP address of the device, storing the IP address in the memory; and
if the message is not received, using one of Reverse Address Resolution Protocol (RARP) and Inverse Address Resolution Protocol (IARP) to obtain the IP address of the device from a media access control (MAC) address of the device.

18. The apparatus of claim 17, wherein the IP address transmitted to the device is randomly assigned from a plurality of available IP addresses.

19. The apparatus of claim 17, wherein the device comprises an embedded device within an industrial control system.

20. The apparatus of claim 17, wherein the transmitted IP address is within a same subnet as an IP address assigned to the apparatus.
